(19) United States
(12) Patent Application Publication
(10) Pub. No.: US 2018/0207487 A1
(43) Pub. Date: Jul. 26, 2018

(54) SCALY STRUCTURE

(71) Applicant: DONGGUAN JIANGHAO PLASTIC PRODUCTS CO., LTD, Dongguan (CN)

(72) Inventor: Yetai Qin, Dongguan (CN)

(21) Appl. No.: 15/541,168

(22) PCT Filed: Apr. 25, 2016
(86) PCT No.: PCT/CN2016/080125

§ 371 Date: Jun. 30, 2017

(30) Foreign Application Priority Data
Oct. 12, 2015 (CN) 201520792604.4

(51) Int. Cl. A63B 31/12; A41D 13/012; A41D 7/00; B32B 3/30

(52) U.S. Cl. CPC A63B 31/12; A41D 13/012; B63C 2011/046; B32B 3/30; A41D 7/00

(57) ABSTRACT

A scaly structure including a carrier and multiple scale films configured on the carrier. The scale films are arranged independently and each has a proximal end that is connected to the carrier and a distal end that is away from the carrier and suspended, and the scale films are bent towards the carrier in the same direction. The scaly structure of the present invention has small friction when it is in smooth position, and the scale structure will be turned and opened oppositely to the bending direction when it is in tough position, bringing increased friction to obstruct the movement.

### FIELD OF THE INVENTION

The invention relates to a bionic structure, and more particularly to a scaly structure.

### BACKGROUND OF THE INVENTION

Bionics is special ability to imitate organisms and is science technology for developing machinery and various new technologies accordingly to the biological structures and principle. At present, there are many bionic structures, such as electronic frog eye developed according to principles of frog eyes, artificial cold light developed according to the light-emitting principle of fireflies, radar developed according to the detection principle of bats.

Currently, submarine is developed according to lifting principle of fishes. Nonetheless, there is still a need to study the principle and the effect of scale structure of fish scales.

### SUMMARY OF THE INVENTION

One objective of the present invention is to provide a scaly structure that imitates the structure of fish scales.

To achieve the above-mentioned objective, the present invention provides a scaly structure including a carrier and multiple scale films configured on the carrier. The scale films are arranged independently and each has a proximal end that is connected to the carrier and a distal end that is away from the carrier and suspended, and the scale films are bent towards the carrier in the same direction.

Similarly to the fish scales, the scaly structure of the present invention includes the multiple scale films arranged on the carrier, each of which has a proximal end that is connected to the carrier and a distal end that is away from the carrier and suspended; differently from the fish scales, the scale films in the present invention are bent towards the carrier in the same direction, instead of fully attached on the carrier. In other words, a gap or a space is formed between adjacent scale films. With such an arrangement, when the scaly structure is in smooth position, that is the movement direction of the scaly structure is opposite to the bending direction of the scale films, the scaly structure has quite small friction; when the scaly structure is in tough position, that is the movement direction of the scaly structure is the same with the bending direction of the scale films, the bent scaled films will be turned and opened opposite to the bending direction, in order to increase the friction to obstruct the movement.

In a preferred embodiment, the scale films in a row are arranged in the same interval, and the scale films in adjacent rows are in staggered arrangement. In such a way multiple scale films form a reticular and interlaced structure to increase the obstruction effect in tough position.

In another preferred embodiment, the scale films in a row are arranged in different intervals, and the scale films in adjacent rows are in staggered arrangement,

Preferably, along a bending direction of the scale films, a scale film covers another scale film that is located in the front.

Preferably, a middle position of the scale film is depressed towards a direction that is away from the carrier, thereby preventing excessive open of the scale film 200 to weaken the obstruction effect.

Preferably, the thickness gradually thins from the proximal end of the scale film to the distal end of the scale film, namely, the scale film tapers from the proximal end to the distal end. Because the suspended distal end is thinner and the proximal end is thicker, thus the distal end is easy to be opened when in tough position, while the proximal end is hard to be opened.

Preferably, the scale films are made of rubber.

Preferably, the carrier is made of flexible material.

Preferably, the scaly structure is applied to surfaces of a movement object, and the movement object has a movement direction same to or opposite to a bending direction of the scale films. Under this situation, the obstruction effect of the scaly structure in tough position is applicative.

Preferably, the scaly structure is applied to outer sides of swimwear or boats. Under this situation, the reduced friction of the scaly structure in smooth position is applicative.

### BRIEF′ DESCRIPTION OF THE DRAWINGS

The accompanying drawings facilitate an understanding of the various embodiments of this invention. In such drawings:

FIG. 1 is a perspective view of a scaly structure according to the present invention;

FIG. 2 is an enlarged view of the portion A in FIG. 1;

FIG. 3 is a sectional view of the FIG. 1 along B-B line; and

FIG. 4 is an enlarged view of the portion C in FIG. 3.

### DETAILED DESCRIPTION OF ILLUSTRATED EMBODIMENTS

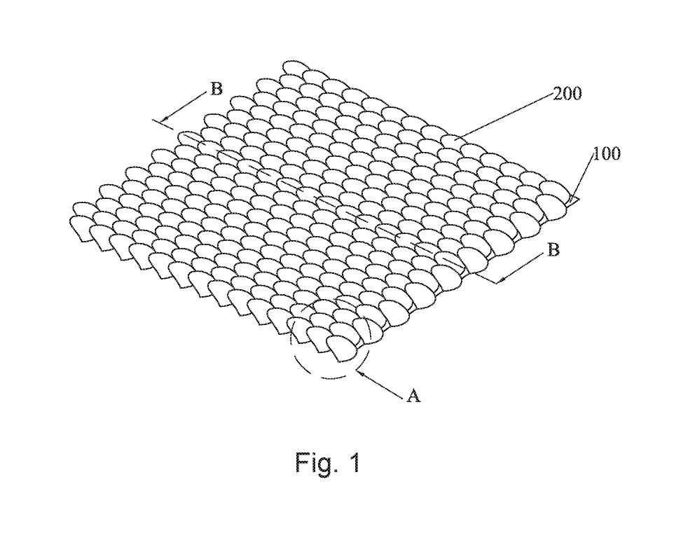

Referring to FIG. 1, the present invention provides a scaly structure including a carrier 100 and multiple scale films 200 configured on the carrier 100. Specifically, the scale films 200 are arranged independently and each scale film 200 has a proximal end connected to the carrier 100 and a distal end that is away from the carrier 100 and suspended, and the scale films 200 are bent towards the carrier 100 in the same direction.

Similarly to the fish scales, the scaly structure of the present invention includes the multiple scale films 200 arranged on the carrier 100, each of which has a proximal end that is connected to the carrier 100 and a distal end that is away from the carrier 100 and suspended; differently from the fish scales, the scale films 200 in the present invention are bent towards the carrier 100 in the same direction, instead of fully attached on the carrier 100. In other words, a gap or a space is formed between adjacent scale films 200. With such an arrangement, when the scaly structure is in smooth position, that is, the movement direction of the scaly structure is opposite to the bending direction of the scale films, the scaly structure has a quite small friction; when the scaly structure is in tough position, that is, the movement direction of the scaly structure is the same with the bending direction of the scale films, the bent scaled films 200 will be turned and opened opposite to the bending direction, in order to increase the friction to obstruct the movement.

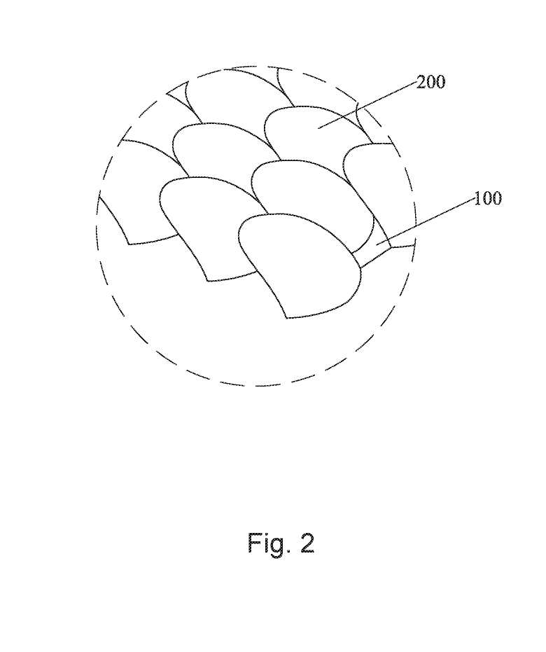

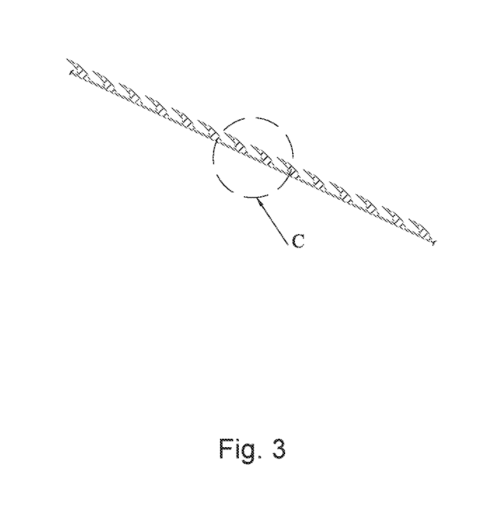

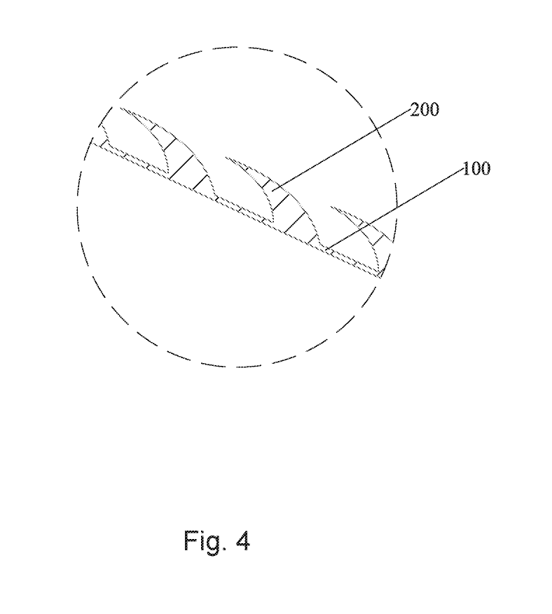

By combination with FIGS. 1-4, specifically, the scale films 200 in the same row are arranged in the same interval, and the scale films 200 in two adjacent rows are in staggered arrangement. In such a way, multiple scale films 200 form a reticular and interlaced structure to increase the obstruction effect in tough position. Specifically, the scale films 200 in the same row are arranged in the same interval, the scale films 200 in odd rows and in even rows have the same arrangements respectively; but the adjacent rows have the staggered arrangement. By this token, the obstruction effect when the scaly structure is in tough position is enhanced. In other embodiment, the scale films 200 in the same row may be arranged in different intervals.

Further, along the bending direction of the scale films 700, a scale film 200 in a behind row partly covers another scale film 200 in a front row. Specifically, the scale films 200 in the behind row are bent towards that in the front row, and a scale film 200 in the behind row partly covers a right side of a scale film 200 and a left side of an adjacent scale film 200 in the front row That is, two adjacent scale films in a row are covered by another scale film that is located behind the two adjacent scale films. In such a way, when any one scale film 200 is turned and opened oppositely to the bending direction, two adjacent scale films 200 behind it will be actuated to turn and open accordingly, as a result, the whole scaly structure will be actuated to generate a big obstruction effect. Meanwhile, in such an arrangement, the distal ends of the scale films 200 that are suspended form a dense, uniform and smooth surface, which reduces the friction when the scaly structure is in tough position.

Referring to FIGS. 1-4, preferably, the distal end of the scale film 200 that fails to connect with the carrier 100 includes a smooth curved outer wall. The middle portion of the scale film 200 is depressed towards a direction that is away from the carrier 100, in order to prevent excessive open of the scale film 200 to weaken the obstruction effect. Further, the thickness gradually thins from the proximal end that is connected to the carrier 100 to the distal end that is away from the carrier 100, that is, the scale film 200 tapers from the proximal end to the distal end. Because the suspended distal end is thinner and the proximal end is thicker, thus the distal end is easy to be turned and opened when in tough position, while the proximal end is hard to be turned and opened. Of course, the distal end of the scale film 200 that fails to connect with the carrier 100 can be configured in different structures according to different fishes, such as pectinate structure similarly to the weever scale, prismatic structure similarly to the eel scale, ctenoid structure similarly to the shark scale, camber structure similarly to the salmon scale. Preferably, the scale films 200 are made of rubber which has good elasticity. Preferably, the carrier 100 is made of flexible material as well, so that the scaly structure of the present invention can be applied to any situation.

The scaly structure can be applied to surfaces of a movement object, and the movement object has a movement direction same to or opposite to a bending direction of the scale films. Under this situation, the obstruction effect of the scaly structure in tough position is applicative.

The scaly structure can be applied to the outer sides of products that are relevant to fluid mechanics, such as swimwear or boats. Under this situation, the reduced friction of the scaly structure in smooth position is applicative.

To be understood, the present invention is aiming at protecting the shape, configuration and arrangement of the scale films 200. The carrier 100 is just a carrier to support such scale films 200. In some situations that the scale films 200 are connected to the outside of a swimwear, a boat or a elevator which is equivalent to a carrier 100, which are included within the spirit and scope of the invention.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

1. A scaly structure, comprising a carrier and multiple scale films configured on the carrier, wherein the scale films are arranged independently and each has a proximal end that is connected to the carrier and a distal end that is away from the carrier and suspended, and the scale films are bent towards the carrier in the same direction.

2. The scaly structure according to claim 1, wherein the scale films in a row are arranged in the same interval, and the scale films in adjacent rows are in staggered arrangement.

3. The scaly structure according to claim 1, wherein the scale films in a row are arranged in different intervals, and the scale films in adjacent rows are in staggered arrangement.

4. The scaly structure according to claim 2, wherein along a bending direction of the scale films, a scale film covers another scale film that is located in the front.

5. The scaly structure according to claim 1, wherein a middle position of the scale film is depressed towards a direction that is away from the carrier.

6. The scaly structure according to claim 1, wherein the thickness gradually thins from the proximal end of the scale film to the distal end of the scale film, namely, the scale film tapers from the proximal end to the distal end.

7. The scaly structure according to claim 1, wherein the scale films are made of rubber.

8. The scaly structure according to claim 1, wherein the carrier is made of flexible material.

9. The scaly structure according to claim 1, wherein the scaly structure is applied to surfaces of a movement object, and the movement object has a movement direction same to or opposite to a bending direction of the scale films.

10. The scaly structure according to claim 1, wherein the scaly structure is applied to outer sides of swimwear or boats.

11. The scaly structure according to claim 3, wherein along a bending direction of the scale films, a scale film covers another scale film that is located in the front.
